(19) United States
(12) Patent Application Publication
(10) Pub. No.: US 2026/0358052 A1
(43) Pub. Date: Nov. 12, 2026

(54) MATERIAL DRYING METHOD AND SYSTEM, AND READABLE STORAGE MEDIUM

(71) Applicant: XIAMEN TOBACCO INDUSTRIAL CO., LTD., Xiamen (CN)

(72) Inventors: Yusheng WU, Xiamen (CN); Hongzhou HE, Xiamen (CN)

(21) Appl. No.: 19/489,345

(22) PCT Filed: Nov. 28, 2024
(86) PCT No.: PCT/CN2024/135107

§ 371 Date: Dec. 2, 2025

(30) Foreign Application Priority Data
Jan. 12, 2024 (CN) 202410050588.5

(51) Int. Cl. F26B 25/22; F26B 21/50; F26B 25/16

(52) U.S. Cl. CPC F26B 25/22; F26B 21/50; F26B 25/16

(57) ABSTRACT

The present disclosure provides a material drying method, system, and readable storage medium. The method comprises: in a preheating mode, closing a fresh air flow path and an exhaust moisture path of a material drying equipment, and conducting the hot air flow path of the material drying equipment to preheat a drum of the material drying equipment; when the temperatures of all zones of the drum reach set values after preheating and incoming material is detected, adjusting the material drying equipment to a material head mode, when the duration of the material head mode reaches Tsb or the maximum moisture content of the dried material output in the material mode is higher than the et moisture content Aₘᵢₙ % of the dried material, adjusting the material drying equipment to a production mode, after the production mode ends, adjusting the material drying equipment to a material tail mode.

### CROSS-REFERENCE TO RELATED APPLICATIONS

The present disclosure is based on a Chinese application with application No. 202410050588.5, filed on Jan. 12, 2024, and claims priority thereto. The disclosure content of the Chinese application is incorporated herein in its entirety by reference.

### TECHNICAL FIELD

The present disclosure relates to the field of material drying, and specifically to a material drying method, system, and readable storage medium.

### BACKGROUND

Drying technology has a very long history of application. In the technical fields of food, herbs, and tobacco processing, material drying is a key process in its processing procedure. The accuracy and uniformity of the material moisture content after drying are particularly important, directly affecting the stability of product quality, as well as the levels of energy saving, emission reduction, and consumption reduction.

The drum of the material drying equipment is a rotary device configured for material drying. The drying method for materials used in traditional drying equipment involves conveying the material into the drum via a conveying device, and achieving the purpose of drying during the helical movement within the drum. The heat energy supply for the drying process consists of two parts. First, the drum wall is heated by the steam injected into pipes on the drum wall, which in turn heats the material via the drum wall to dehydrate it. From the feed end to the discharge end of the drum, the drum wall temperature in the entire drum is basically consistent. The adjustment of drum wall temperature is achieved by adjusting pressure of the injected steam. Second, the material undergoes auxiliary heating by process hot air and the steam evaporated from the material is carried away, thereby achieving the purpose of drying.

The main control parameters of the drying equipment include: material flow rate, steam pressure, hot air temperature, hot air fan frequency, and exhaust moisture damper opening degree. The adjustment method adopted by existing material drying equipment is to set corresponding control parameters such as material flow rate, steam pressure, hot air temperature, hot air fan frequency, and exhaust moisture damper opening degree according to the processing intensity requirements of different materials. Through the adjustment of these parameters, the moisture content of different materials meets the process requirements, completing the process task of the drying equipment.

The inventors found that the related technology at least has the following problems: the existing material drying method easily causes loss of material aroma during the processing, and is not conducive to improving the poor sensory quality caused by offensive odor and irritancy. The sensory quality of the product is difficult to control, the material breakage rate is high and the filling capacity is low, and the uniformity of material moisture content after drying is poor.

### SUMMARY

The present disclosure proposes a material drying method, system, and readable storage medium, configured to provide the drying quality of materials.

The embodiment of the present disclosure provides a material drying method, including the following steps:
in a preheating mode, closing a fresh air flow path and an exhaust moisture flow path of a material drying equipment, and conducting the hot air flow path of the material drying equipment to preheat a drum of the material drying equipment; wherein, the drum is divided into a preheating and temperature rising zone, an isothermal drying zone, a moisture adjustment zone, and a heat preservation and balancing zone;
when the temperatures of all zones of the drum after preheating reach set values, and incoming material is detected, adjusting the material drying equipment to a material head mode;
when the duration of the material head mode reaches T_{sb} or the maximum moisture content of the dried material output in the material head mode is higher than the set minimum moisture content Aₘᵢₙ % of the dried material, adjusting the material drying equipment to a production mode;
after the production mode ends, adjusting the material drying equipment to a material tail mode.

In some embodiments, in the preheating mode, the temperature in the preheating and temperature rising zone of the drum is lower than the temperature in the preheating and temperature rising zone of the drum in the material head mode, the production mode, and the material tail mode.

In some embodiments, in the preheating mode, the temperature in the isothermal drying zone of the drum is lower than the temperature in the isothermal drying zone of the drum in the material head mode, the production mode, and the material tail mode.

In some embodiments, in the preheating mode, the temperature in the moisture adjustment zone of the drum is lower than the temperature in the moisture adjustment zone of the drum in the material head mode, the production mode, and the material tail mode.

In some embodiments, in the preheating mode, the temperature in the cooling and setting zone of the drum is lower than the temperature in the cooling and setting zone of the drum in the material head mode, the production mode, and the material tail mode.

In some embodiments, in the production mode, the temperature in the preheating and temperature rising zone is t₁₋₃+Δt₁₋₃, the drum wall temperature in the isothermal drying zone is t₂₋₃±Δt₂₋₃, the drum wall temperature in the moisture adjustment zone is t₃₋₃±Δt₃₋₃, the temperature in the cooling and setting zone is t₄₋₃±Δt₄₋₃; the ambient temperature is t₀; wherein, t₀≤t₁≤t₂≥t₃≥t₄≥t₀.

In some embodiments, in the preheating mode, the fresh air damper in the fresh air flow path is closed, the exhaust moisture fan in the exhaust moisture flow path is closed, and the exhaust moisture damper in the exhaust moisture flow path is closed.

In some embodiments, in the production mode, the opening degrees of the exhaust moisture damper in the exhaust moisture flow path and the fresh air damper in the fresh air flow path are both 100%, the air flow rate of the exhaust moisture flow path is achieved by adjusting the operating frequency of the exhaust moisture fan, the air flow rate of the fresh air flow path is achieved by adjusting the opening degree of the fresh air damper, and the opening degree of the return air damper of the material drying equipment is 0%; or, in the production mode, the opening degrees of the exhaust moisture damper in the exhaust moisture flow path and the fresh air damper in the fresh air flow path are both 100%, and the opening degree of the return air damper of the material drying equipment is 0%.

In some embodiments, in the material tail mode, the opening degree of the exhaust moisture damper in the exhaust moisture flow path is less than the opening degree of the exhaust moisture damper in the exhaust moisture flow path in the production mode; and/or, in the material tail mode, the frequency of the exhaust moisture fan in the exhaust moisture flow path is less than the operating frequency of the exhaust moisture fan in the exhaust moisture flow path in the production mode; and/or, in the material tail mode, the opening degree of the fresh air damper in the fresh air flow path is less than the opening degree of the fresh air damper in the fresh air flow path in the production mode; and/or, in the material tail mode, the opening degree of the return air damper of the material drying equipment is greater than the opening degree of the return air damper in the production mode.

In some embodiments, when a material detection device arranged on a conveying device detects a no-material signal, the material drying equipment is adjusted from the production mode to the material tail mode; wherein, the conveying device is located upstream of the material drying equipment.

In some embodiments, after the material tail mode, the method further comprises the following step: adjusting the material drying equipment from the material tail mode to a shutdown mode.

In some embodiments, when the material detection devices on both the upstream and downstream conveying devices of the material drying equipment detect no-material signals and delay for a set time, the material drying equipment is adjusted from the material tail mode to the shutdown mode.

In some embodiments, when the exhaust moisture air temperature Tₒᵤₜ is less than or equal to a set value, and the drum wall temperatures of the preheating and temperature rising zone, the isothermal drying zone, the moisture adjustment zone, and the heat preservation and balancing zone are all less than or equal to their respective set temperatures, the material drying equipment shuts down and stops running.

In some embodiments, in the shutdown mode, the return air damper of the material drying equipment, the heater of the hot air flow path, and the heating component outside the drum are all closed.

In some embodiments, in the production mode, when the relative humidity of the exhaust moisture air is greater than the set relative humidity RHₒᵤₜ+Δ RHₒᵤₜ of exhaust moisture air, increasing the hot air flow rate Qₕₒₜ₋₃; when the relative humidity of the exhaust moisture air is less than the set relative humidity RHₒᵤₜ−Δ RHₒᵤₜ of exhaust moisture air, decreasing the hot air flow rate Qₕₒₜ₋₃.

In some embodiments, in the production mode, if the moisture content of the material output after drying by the drum is greater than the set moisture content A %+ΔA % of the dried material, then increasing the hot air flow rate Qₕₒₜ₋₃ and/or raising the drum wall temperature t₃₋₃ in the moisture adjustment zone; if the moisture content of the material output after drying by the drum is less than the set moisture content A %−ΔA % of the dried material, then decreasing the hot air flow rate Qₕₒₜ₋₃ and/or lower the drum wall temperature t₃₋₃ in the moisture adjustment zone.

In some embodiments, in the production mode, if the moisture content of the material output after drying by the drum is greater than the set moisture content A %+ΔA % of the dried material, then performing adjustment according to the following steps:
raising the drum wall temperature t₃₋₃ in the moisture adjustment zone;
if after raising the drum wall temperature t₃₋₃ in the moisture adjustment zone to t₃₋₃+Δt₃₋₃, the moisture content of the material output after drying by the drum is still greater than the set moisture content A %+ΔA % of the dried material, then increasing the hot air flow rate Qₕₒₜ₋₃.

In some embodiments, in the production mode, if the moisture content of the material output after drying by the drum is less than the set moisture content A %−ΔA % of the dried material, then performing adjustment according to the following steps:
lowering the drum wall temperature t₃₋₃ in the moisture adjustment zone;
if after lowering the drum wall temperature t₃₋₃ in the moisture adjustment zone to t₃₋₃−Δt₃₋₃, the moisture content of the material output after drying by the drum is still less than the set moisture content A %−ΔA % of the dried material, then decreasing the hot air flow rate Qₕₒₜ₋₃.

In some embodiments, in the production mode, when the temperature of the dried material is greater than Tₒᵤₜ+ΔTₒᵤₜ, increasing the exhaust moisture air flow rate Q(out−3), thereby increasing the natural air flow rate Q_{new}; when the temperature of the dried material is less than Tₒᵤₜ−ΔTₒᵤₜ, decreasing the exhaust moisture air flow rate Q(out−3), thereby decreasing the natural air flow rate Q_{new}.

In some embodiments, in the production mode, always maintaining the exhaust moisture air flow rate Qₒᵤₜ equal to the hot air flow rate Qₕₒₜ plus the natural air flow rate Q_{new}, i.e., Qₒᵤₜ=Qₕₒₜ+Q_{new}.

In some embodiments, each of the material head mode, the production mode, and the material tail mode comprises the following operation:
detecting the moisture content of the material output after drying by the drum;
if the detected moisture content of the material is greater than the set maximum moisture content Aₘₐₓ % of the dried material or less than the set minimum moisture content Aₘᵢₙ % of the dried material, then discarding the material.

The embodiment of the present disclosure also provides a material drying system, comprising:
a memory; and
a processor coupled to the memory, the processor being configured to execute the material drying method provided by any technical solution of the present disclosure based on instructions stored in the memory.

The embodiment of the present disclosure further provides a computer-readable storage medium, having a computer program stored thereon, which when executed by a processor, implements the material drying method provided by any technical solution of the present disclosure.

The material drying method provided by the above technical solution can more accurately control the moisture content of the material, completely eliminating problems in the related art caused by the undifferentiated setting of the drum wall temperature of the material drying equipment, such as loss of work-in-progress aroma, poor moisture content uniformity, poor filling capacity, and raw material waste. It improves the sensory quality of the product, enhances the stability of product quality, increases the filling capacity of the work-in-progress, and reduces raw material loss.

### BRIEF DESCRIPTION OF THE DRAWINGS

The drawings described herein are provided to provide further understanding of the present disclosure and constitute a part of this application. The schematic embodiments of the present disclosure and their descriptions are used to explain the present disclosure and do not constitute an improper limitation of the present disclosure. In the drawings:

FIG. 1 is a schematic structural diagram of material drying equipment for implementing the material drying method provided by the embodiment of the present disclosure.

FIG. 2 is a schematic diagram of the hot air flow path and the exhaust moisture flow path of the material drying equipment for implementing the material drying method provided by the embodiment of the present disclosure.

FIG. 3 is a schematic diagram for implementing the material drying method provided by the embodiment of the present disclosure.

### REFERENCE NUMERALS

1. Drum; 11. Preheating and Temperature Rising Zone; 111. First Temperature Sensor; 12. Isothermal Drying Zone; 121. Second Temperature Sensor; 13. Moisture Adjustment Zone; 131. Third Temperature Sensor; 14. Heat Preservation and Balancing Zone; 141. Fourth Temperature Sensor; 2. Hot Air Flow Path; 3. Support Frame; 4. Drum Drive System; 5. Temperature Gauge; 6. Moisture Gauge; 7. Conveying Device; 71. Discarding Device; 8. Discharge Hood; 81. Discharge Outlet; 9. Exhaust Moisture Flow Path; 8′. Cooling and Setting Zone; 10. Feed Hood; 15. Fresh Air Flow Path;
The hot air flow path 2 includes: 21. Hot Air Fan; 22. Heater; 23. Counter-flow Hot Air Damper; 24. Concurrent-flow Hot Air Damper; 25. Fresh Air Damper; 26. Return Air Damper; 27. Hot Air Temperature Gauge;
The exhaust moisture flow path 9 includes: 91. Exhaust Moisture Fan; 92. Exhaust Gas Humidity Gauge; 93. Exhaust Gas Temperature Gauge; 94. Exhaust Moisture Damper; 95. Concurrent-flow Exhaust Damper; 96. Counter-flow Exhaust Damper;
Direction A is the flow direction of the exhaust gas (mixed gas of process hot air and natural air); Direction B is the flow direction of the process hot air; Direction C is the flow direction of the dried material.

### DETAILED DESCRIPTION

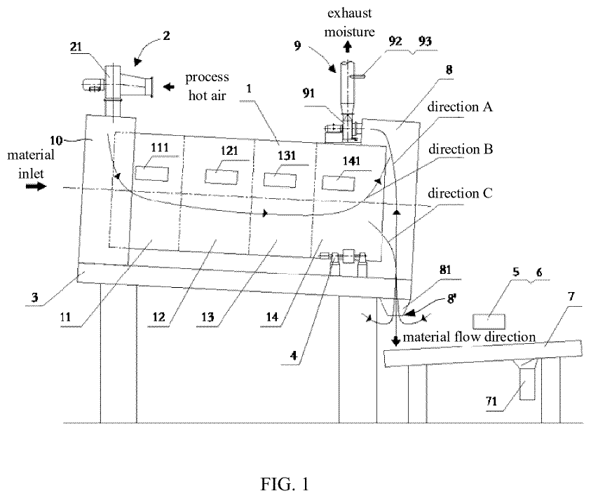

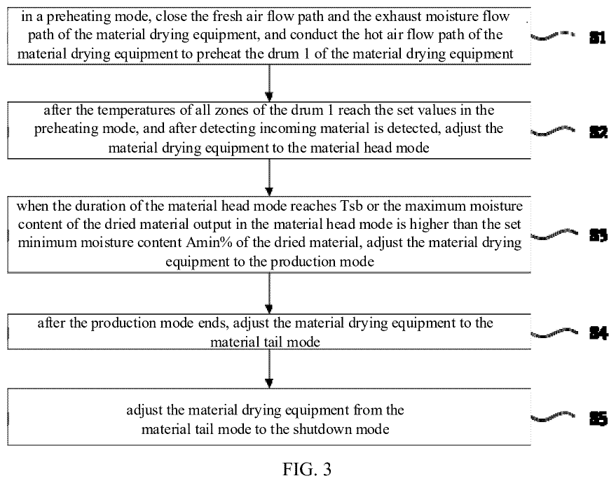

The technical solutions provided by the present disclosure will be described in more detail below with reference to FIG. 1 to FIG. 3. The description of the exemplary embodiments is merely illustrative and shall not be construed as any limitation on the present disclosure and its application or use. The present disclosure may be implemented in many different forms and is not limited to the embodiments described herein. These embodiments are provided to make the present disclosure thorough and complete, and to fully convey the scope of the present disclosure to those skilled in the art. It should be noted that unless otherwise specifically stated, the relative arrangement of components and steps, the material composition, numerical expressions, and numerical values set forth in these embodiments should be interpreted as merely exemplary, and not as limiting.

The terms “first”, “second” and similar words used in the present disclosure do not denote any order, quantity, or importance, but are only used to distinguish different parts. The terms “include” or “comprise” and similar words mean that the elements preceding the word encompass the elements listed following the word, and do not exclude the possibility that it also encompasses other elements.

In the present disclosure, when describing that a specific device is located between a first device and a second device, there may or may not be an intermediary device between the specific device and the first device or the second device. When describing that a specific device is connected to another device, the specific device may be directly connected to the other device without an intermediary device, or may not be directly connected to the other device and have an intermediary device in between.

All terms (including technical terms or scientific terms) used in the present disclosure have the same meanings as understood by a person of ordinary skill in the art to which the present disclosure belongs, unless otherwise specifically defined. It should also be understood that terms defined in general dictionaries should be interpreted as having meanings consistent with their meanings in the context of the relevant technology, and should not be interpreted in an idealized or extremely formalized sense unless explicitly defined herein.

Techniques, methods, and devices known to those of ordinary skill in the relevant art may not be discussed in detail, but where appropriate, the techniques, methods, and devices should be considered as part of the description.

The dimensions of the various parts shown in the drawings are not drawn according to the actual scale relationship. The same reference numerals are assigned to common structural elements or the same kind of structural elements in the drawings, and repeated descriptions thereof are appropriately omitted.

The inventors found through research that:
(1) The main reason for the loss of material aroma during the processing is: in traditional drying process technology, after the material enters the drum, the temperature difference between the material and the drum wall is large, and rising rate of the material temperature is too high, causing the cytoplasmic fluid to expand rapidly to lead to cell wall rupture and the loss of soluble substances, thereby resulting in product aroma loss and reduced product sensory quality.
(2) The main reasons for the high material breakage rate and low filling capacity are: the same high drying temperature is used throughout the entire drying process for the material, and the continuous long-term high-temperature heating of the material in the drum 1 reduces the processability of the material, causing breakage in subsequent processing. Additionally, after the material is delivered from the discharge end of the drum 1 to the subsequent conveying device, the temperature difference between the material and the natural environment is large, and when the material encounters cold air, cooling rate of the material is excessive, resulting in material breakage, thereby affecting filling capacity and raw material utilization rate of the material.
(3) The main reasons for the poor uniformity of material moisture content after drying are: when the moisture content of the dried material is high or low, method one is to adjust the drum wall temperature of the drum. This method requires adjusting the temperature of the entire drum. Due to the large thermal inertia of the drum and the low sensitivity of temperature adjustment, the uniformity of the moisture content of the dried material is poor, and the overall processing strength of the material is also affected, causing fluctuations in product sensory quality. Method two is achieved by substantially adjusting the hot air flow rate. This method changes the residence time of the material in the drum, affects the drying time of the material in the drum, resulting in poor uniformity of the moisture content of the dried material and/or insufficient chemical reaction of the material, and the situation of “dry outside and wet inside” for the dried material. Furthermore, after the dried material enters the conveying device, during the natural cooling process on the conveying device, the outer surface material in direct contact with the ambient air has a higher cooling rate and lower moisture content, while the inner layer material has a smaller cooling rate and higher moisture content.

Through creative work, the inventors have proposed the following technical solution, which can reduce the loss of material aroma during the processing, result in low material breakage rate and high filling capacity, achieve good uniformity of material moisture content after drying, and provide better product sensory quality control.

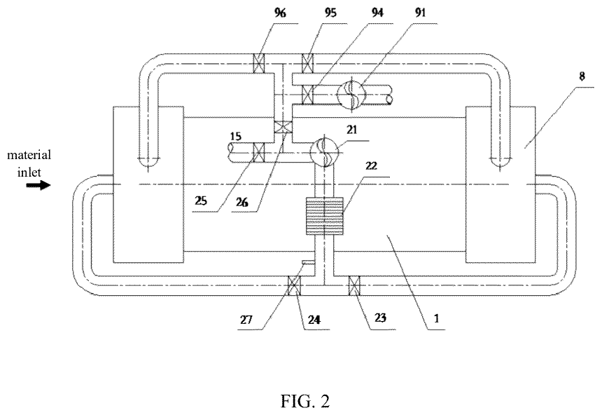

To facilitate the description of the material drying method provided by the embodiment of the present disclosure, the material drying equipment for implementing this method is first introduced. Referring to FIG. 1 and FIG. 2, the material drying equipment is specifically, for example, a drum dryer. The material drying equipment includes a feed hood 10, a drum 1, a discharge hood 8, a hot air flow path 2, a fresh air flow path 15, an exhaust moisture flow path 9, a conveying device 7, and a discarding device 71.

The drum 1 is provided with a feed inlet and a discharge outlet. The drum 1 is mounted on a support frame 3 and is driven by a drum drive system 4 to rotate about its central axis. The external part of the drum 1 is divided into zones and wrapped with heating components (not shown in the figure). The heating components of each zone can be fixedly connected to the drum 1 to rotate synchronously with the drum 1. Alternatively, the heating components of each zone can also be fixed, with a certain gap from the outer wall of the drum 1, and the heating components do not rotate with the drum 1. Alternatively, the heating components in some zones of the external part of the drum 1 can rotate with the drum 1, while the rest of the heating components do not rotate with the drum 1. In some embodiments described later, along the axial direction of the drum 1, and along the direction from the feed inlet to the discharge outlet of the drum 1, the drum 1 is divided into four zones: a preheating and temperature rising zone 11, an isothermal drying zone 12, a moisture adjustment zone 13, and a heat preservation and balancing zone 14. The temperature of the heating components separately provided outside each zone is independently controlled to achieve precise zonal control of the drum wall temperature of the drum 1. The heating components are, for example, electromagnetic coils.

The feed hood 10 is arranged at the feed inlet of the drum 1, and the discharge hood 8 is arranged at the discharge outlet of the drum 1.

The hot air flow path 2 includes a hot air fan 21, a heater 22, a hot air temperature gauge 27, a concurrent-flow hot air damper 24, a concurrent-flow exhaust damper 95, a counter-flow hot air damper 23, and a counter-flow exhaust damper 96. The hot air flow path is connected to the interior of the drum 1, and the hot air flow path 2 is used to deliver process hot air into the interior of the drum 1. Specifically, a hot air pipe (not shown in the figure) can be arranged to deliver the process hot air. The hot air pipe runs through the interior of the drum 1, and the length direction of the hot air pipe is substantially along the axial direction of the drum 1. The middle position of the hot air pipe is provided with a hot air baffle, and the pipe wall of the hot air pipe is provided with openings. The hot air can flow in from the port at either end of the hot air pipe, then flow out from the openings in the pipe wall of the hot air pipe and enter the interior of the drum 1, and the hot air entering the interior of the drum 1 can contact the material to achieve heat exchange and dehumidification.

The exhaust moisture flow path 9 is connected to the interior of the drum 1, and the exhaust moisture flow path 9 is used to discharge the exhaust gas from the interior of the drum 1. Generally, the exhaust moisture flow path 9 is in communication with the discharge hood 8 and/or the exhaust moisture flow path 9 is in communication with the feed hood 10. The exhaust moisture flow path 9 includes an exhaust moisture fan 91, an exhaust gas humidity gauge 92, an exhaust gas temperature gauge 93, and an exhaust moisture damper 94.

The interior of the discharge hood 8 is a cooling and setting zone 8′. The lower part of the discharge hood 8 is provided with a discharge outlet 81, and the material falls naturally by gravity through the discharge outlet onto the conveying device 7.

A conveying device 7 and a discarding device 71 thereon are provided downstream of the material drying equipment. A temperature gauge 5 and a moisture gauge 6 are provided above the conveying device 7 to detect the temperature and moisture content of the dried material in real time.

The material used in the present disclosure is flake, filamentous, or thin rod-shaped material. In some subsequent embodiments, cut tobacco is taken as an example.

Before introducing the technical solution of the embodiment of the present disclosure, the parameters of the material drying equipment and the process requirements for the material entering the material drying equipment are first introduced.

Once the model of the material drying equipment is selected, the length of the drum 1 of the material drying equipment and the diameter of the drum 1 are known. Based on these parameters, parameters such as the cross-sectional area of the drum 1 can be obtained, and thus the material flow rate can be set. The inclination angle of the drum 1 from the feed end to the discharge end is adjustable from 2° to 6°. The drying time of the material in the drum 1 is adjusted by the inclination angle and the rotational speed of the drum 1.

Process parameter requirements include but are not limited to the following items: material flow rate of the material drying equipment, material inlet moisture content, material outlet moisture content, material inlet temperature, material outlet temperature, material drying time, and the physical quality and sensory quality of the dried material, etc. For a material drying equipment with a determined model, the specific value ranges of the above process requirements are determined by the process technology department according to the type of material to be processed.

The material drying method provided by the embodiment of the present disclosure mainly controls the temperature of each zone of the drum 1, the hot air flow rate, and the exhaust moisture air flow rate.

TABLE 1
Drum wall Temperature of Each Zone of the Drum in Each Mode

| | Preheating | | | | | | Heat | |
|---|---|---|---|---|---|---|---|---|
| | and | | | | | | Preservation | |
| | Temperature | | Isothermal | | Moisture | | and | |
| | Rising | | Drying | | Adjustment | | Balancing | |
| | Zone t₁ | | Zone t₂ | | Zone t₃ | | Zone t₄ | |
| Preheating | t₁₋₁ ± | Δt₁₋₁ | t₂₋₁ ± | Δt₂₋₁ | t₃₋₁ ± | Δt₃₋₁ | t₄₋₁ ± | Δt₄₋₁ |
| Mode | 100 ± | 1 °C | 110 ± | 1 °C | 100 ± | 1 °C | 95 ± | 1 °C |
| Material | t₁₋₂ ± | Δt₁₋₂ | t₂₋₂ ± | Δt₂₋₂ | t₃₋₂ ± | Δt₃₋₂ | t₄₋₂ ± | Δt₄₋₂ |
| Head Mode | 105 ± | 2 °C | 118 ± | 2 °C | 105 ± | 5 °C | 100 ± | 2 °C |
| Production | t₁₋₃ ± | Δt₁₋₃ | t₂₋₃ ± | Δt₂₋₃ | t₃₋₃ ± | Δt₃₋₃ | t₄₋₃ ± | Δt₄₋₃ |
| Mode | 110 ± | 0.5 °C | 128 ± | 0.5 °C | 110 ± | 10 °C | 105 ± | 0.5 °C |
| Material | t₁₋₄ ± | Δt₁₋₄ | t₂₋₄ ± | Δt₂₋₄ | t₃₋₄ ± | Δt₃₋₄ | t₄₋₄ ± | Δt₄₋₄ |
| Tail Mode | 105 ± | 2 °C | 120 ± | 2 °C | 105 ± | 5 °C | 100 ± | 2 °C |

| | | | | |
|---|---|---|---|---|
| Shutdown | t₁₋₅ | t₂₋₅ | t₃₋₅ | t₄₋₅ |
| Mode | 60 °C | 60 °C | 60 °C | 60 °C |

TABLE 2
Hot Air Parameters and Exhaust Moisture Air Parameters of the
Material Drying Equipment in Each Mode

| | | | | | | | Exhaust | Exhaust |
|---|---|---|---|---|---|---|---|---|
| | | | | | | | Moisture | Moisture |
| | | | | | Exhaust | | Air | Air |
| | Hot Air | | Hot Air | | Moisture Air | | Tem- | Relative |
| | Flow Rate | | Temperature | | Flow Rate | | perature | Humidity |
| Set Value | Qₕₒₜ ± | ΔQₕₒₜ | Tₕₐ ± | ΔTₕₐ | Qₒᵤₜ ± | ΔQₒᵤₜ | Tₒᵤₜ | RHₒᵤₜ ± |
| | | | | | | | | ΔRHₒᵤₜ |
| Preheating | 900 ± | 100 m³/h | 100 ± | 1 °C | 0 | m³/h | — | — |
| Mode | | | | | | | | |
| Material | 400 ± | 100 m³/h | 100 ± | 2 °C | 550 ± | 100 m³/h | — | — |
| Head | | | | | | | | |
| Mode | | | | | | | | |
| Production | 1000 ± | 100 m³/h | 102 ± | 0.5 °C | 1200~1800 | | — | 50% ± 5% |
| Mode | | | | | m₃/h | | | |
| Material | 500 ± | 100 m³/h | 100 ± | 2 °C | 650 ± | 100 m³/h | — | — |
| Tail Mode | | | | | | | | |

| Shutdown | Open to | Heater 22 | Greater than or | 60 °C | — |
|---|---|---|---|---|---|
| Mode | maximum | closed | equal to hot air | | |
| | flow rate | | flow rate | | |

In Table 1 above, in the preheating mode, material head mode, production mode, and material tail mode, the temperatures of the preheating and temperature rising zone 11, the isothermal drying zone 12, the moisture adjustment zone 13, and the heat preservation and balancing zone 14 are all range values. According to the process parameters in each mode and the temperature values obtained from real-time detection, the temperature of each zone of the drum 1 can be adjusted in real time to keep it within the range defined in the above table, and adjusted timely within the limited range according to the target moisture content of the material. In Table 2 above, in the shutdown mode, it is necessary to reduce the temperature in the preheating and temperature rising zone 11, the isothermal drying zone 12, the moisture adjustment zone 13, and the heat preservation and balancing zone 14. By opening the hot air flow rate to the maximum, closing the heater 22 to reduce the hot air temperature, and adjusting the exhaust moisture air flow rate to be greater than or equal to the hot air flow rate, the cooling efficiency can be improved.

TABLE 3
Set Parameters of the Material

| | | Set | Set | |
|---|---|---|---|---|
| | | Maximum | Minimum | Set |
| | | Moisture | Moisture | Tem- |
| | Moisture | Content | Content | perature |
| | Content of | of | of | of the |
| | the Dried | the Dried | the Dried | Dried |
| | Material | Material | Material | Material |
| Set Value | Δ % ± ΔA % | Aₘₐₓ % | Aₘᵢₙ % | tₒᵤₜ ± Δtₒᵤₜ |
| Production | 12.8% ± 0.5% | 14.5% | 7.0% | 45 °C ± 3 °C |
| Mode | | | | |

TABLE 4
Status of the Material Drying Equipment in Each Mode

| | | Material | | Material | |
|---|---|---|---|---|---|
| | Preheating | Head | Production | Tail | Shutdown |
| | Mode | Mode | Mode | Mode | Mode |
| Hot Air Fan | Lower | Increase | Frequency | Decrease | Frequency |
| | frequency | frequency | adjusted | frequency | can be |
| | | | timely | | increased |
| Heater | On | Gradually | Adjusted | Gradually | Off |
| | | increase | timely | decrease | |
| Fresh Air | Closed | Increase | Opening | Decrease | Opening |
| Damper | | opening | degree | opening | degree |
| | | degree | 100% | degree | 100% |
| Return Air | Opening | Decrease | Closed | Increase | Closed |
| Damper | degree | opening | | opening | |
| | 100% | degree | | degree | |
| Exhaust | Closed | Increase | Frequency | Decrease | Frequency |
| Moisture | | frequency | adjusted | frequency | can be |
| Fan | | | timely | | increased |
| Exhaust | Closed | Increase | Opening | Decrease | Opening |
| Moisture | | opening | degree | opening | degree |
| Damper | | degree | 100% | degree | 100% |
| Concurrent- | Opening | Maintain | Maintain | Maintain | Maintain |
| flow Hot Air | degree | | | | |
| Damper | 100% | | | | |
| Concurrent- | Opening | Maintain | Maintain | Maintain | Maintain |
| flow | degree | | | | |
| Exhaust | 100% | | | | |
| Damper | | | | | |
| Counter- | Closed | Maintain | Maintain | Maintain | Maintain |
| flow Hot Air | | | | | |
| Damper | | | | | |
| Counter- | Closed | Maintain | Maintain | Maintain | Maintain |
| flow | | | | | |
| Exhaust | | | | | |
| Damper | | | | | |

It should be noted that, due to the limitation of the table size, Table 4 shows one possible flow path mode for the preheating mode. Actually, the material drying equipment can also adopt other preheating flow paths. The three flow path setup methods for the preheating mode will be introduced in detail later. In Table 4, the opening degrees of the fresh air damper, return air damper, exhaust moisture damper, concurrent-flow hot air damper, and concurrent-flow exhaust damper affect the airflow resistance; the larger the opening degree, the smaller the resistance.

The parameters in this context are defined as follows: the drum wall temperature in the preheating and temperature rising zone 11 is t₁+Δt₁, the drum wall temperature in the isothermal drying zone 12 is t₂+Δt₂, the drum wall temperature in the moisture adjustment zone 13 is t₃=Δt₃, and the drum wall temperature in the heat preservation and balancing zone 14 is t₄+Δt₄. The cooling and setting zone corresponds to the dried material, and the set temperature of the dried material is Tₒᵤₜ±ΔTₒᵤₜ.

t₂ is the main drying temperature required by the process, determined by the process technology department. Setting the ambient temperature as t₀, then t₀≤t₁≤t₂≥t₃≥t₄≥t₀. From Table 1, it can be seen that all the temperature range of t₄ are greater than the ambient temperature t₀. Based on this, the material is first preheated in the preheating and temperature rising zone 11 with lower temperature, reducing or even avoiding a too high temperature rise rate of the material after entering the drum 1, which reduces the product sensory quality, better retains the aroma of the material, and improves the drying quality, because a too high rise rate of the material temperature causes the cytoplasmic fluid to expand rapidly, leading to cell wall rupture and the loss of soluble substances.

The set value t₂ of the temperature in the isothermal drying zone 12 is the main dehydration and chemical reaction process of the material. In this zone, the material dehydration rate is the highest, and the rate of chemical reactions such as the Maillard reaction is the fastest. Its temperature setting directly affects the moisture content of the processed material and the sensory quality of the final product.

The moisture adjustment zone 13 is the feedback adjustment zone for the moisture content of the dried material. The material has completed most of the dehydration and chemical reactions in the first two stages. In the moisture adjustment zone 13, the dehydration rate and chemical reaction rate of the material have become relatively slow, and small-range temperature adjustments have less impact on the dehydration rate and chemical reaction rate of the material. To reduce or even avoid the reduction of physical properties of the material under continuous high-temperature drying conditions, the temperature t₃ in this zone is set to be lower than the drum wall temperature t₂ in the isothermal drying zone 12, preventing the material from being over-dried and producing a burnt smell. The heat preservation and balancing zone 14 makes the moisture content and chemical reaction progress of the material more uniform. The drum wall temperature t₄ in this zone is lower than or equal to the drum wall temperature t₃ in the moisture adjustment zone 13, reducing or even avoiding the continuous temperature rise of the material, further ensuring the physical properties of the material, optimizing the processability of the material, and balancing the moisture content of the material, making the temperature and moisture content between materials in different parts more uniform.

In the cooling and setting zone 8′, the dried material within the discharge hood is pre-cooled with the mixed gas of process hot air and cold air, reducing or even avoiding the breakage due to a too high cooling rate when the material is delivered from the discharge outlet 81 of the drum 1 to the conveying device 7 and encounters cold air, and reducing or even avoiding the problem of poor cooling uniformity on the conveying device (the outer surface material in direct contact with the ambient air has a higher cooling rate, while the inner layer material has a smaller cooling rate), thereby improving cooling uniformity.

The preheating and temperature rising zone 11 is provided with a first temperature sensor 111 for collecting the temperature of this zone. The isothermal drying zone 12 is provided with a second temperature sensor 121 for collecting the temperature of this zone. The moisture adjustment zone 13 is provided with a third temperature sensor 131 for collecting the temperature of this zone. The heat preservation and balancing zone 14 is provided with a fourth temperature sensor 141 for collecting the temperature of this zone. The temperature of each zone of the drum 1 is collected and controlled separately. The temperature of the material after cooling and setting is collected in real time by the temperature gauge 5.

In the various modes described later, the first temperature sensor 111 detects the drum wall temperature in the preheating and temperature rising zone 11 in real time. When the drum wall temperature is higher than the set value, the power of the heating component outside the drum wall in the corresponding zone is reduced; when the drum wall temperature is lower than the set value, the power of the heating component outside the drum wall in the corresponding zone is increased.

In the various modes described later, the second temperature sensor 121 detects the drum wall temperature in the isothermal drying zone 12 in real time: when the drum wall temperature is higher than the set value, the power of the heating component outside the drum wall in the corresponding zone is reduced; when the drum wall temperature is lower than the set value, the power of the heating component outside the drum wall in the corresponding zone is increased.

In the various modes described later, the third temperature sensor 131 detects the drum wall temperature in the moisture adjustment zone 13 in real time: when the drum wall temperature is higher than the set value, the power of the heating component outside the drum wall in the corresponding zone is reduced; when the drum wall temperature is lower than the set value, the power of the heating component outside the drum wall in the corresponding zone is increased.

In the various modes described later, the fourth temperature sensor 141 detects the drum wall temperature in the heat preservation and balancing zone 14 in real time: when the drum wall temperature is higher than the set value, the power of the heating component outside the drum wall in the corresponding zone is reduced; when the drum wall temperature is lower than the set value, the power of the heating component outside the drum wall in the corresponding zone is increased.

In the various modes described later, the hot air temperature gauge 27 detects the hot air temperature in real time: when the hot air temperature is higher than the set value, the power of the heater 22 is reduced; when the hot air temperature is lower than the set value, the power of the heater 22 is increased.

In various embodiments, the hot air flow rate adjustment is achieved by adjusting the frequency of the hot air fan 21: the hot air flow rate is increased by increasing the operating frequency of the hot air fan 21, and the hot air flow rate is decreased by decreasing the operating frequency of the hot air fan 21.

In various embodiments, the exhaust moisture air flow rate adjustment is achieved by adjusting the frequency of the exhaust moisture fan 91. The exhaust moisture air flow rate is increased by increasing the operating frequency of the exhaust moisture fan 91, and the exhaust moisture air flow rate is decreased by decreasing the operating frequency of the exhaust moisture fan 91.

The exhaust moisture air temperature is obtained by detection with the exhaust gas temperature gauge 93, and the hot air temperature is obtained by detection with the hot air temperature gauge 27.

In some embodiments, the hot air flow rate is Qₕₒₜ±ΔQₕₒₜ, the hot air temperature is Tₕₐ+ΔTₕₐ, the exhaust moisture air flow rate is Qₒᵤₜ±ΔQₒᵤₜ, the exhaust moisture air temperature is Tₒᵤₜ, and the natural air flow rate is Q_{new}±ΔQ_{new}.

The exhaust moisture air flow rate Qₒᵤₜ equals the hot air flow rate Qₕₒₜ plus the natural air flow rate Q_{new}, i.e., Qₒᵤₜ=Qₕₒₜ+Q_{new}.

Set relative humidity of the exhaust moisture air as RHₒᵤₜ+Δ RHₒᵤₜ, set the moisture content of the dried material as A %±ΔA %, set the maximum moisture content of the dried material as Aₘₐₓ%, set the minimum moisture content of the dried material as Aₘᵢₙ %. Set the temperature of the dried material as Tₒᵤₜ±ΔTₒᵤₜ.

The embodiment of the present disclosure provides a material drying method, which can be applied to the processing of food, herbs, tobacco, and other materials. The material drying method includes the following steps:

Step S1, in a preheating mode, close the fresh air flow path and the exhaust moisture flow path of the material drying equipment, and conduct the hot air flow path of the material drying equipment to preheat the drum 1 of the material drying equipment; wherein, the drum 1 is divided into a preheating and temperature rising zone 11, an isothermal drying zone 12, a moisture adjustment zone 13, and a heat preservation and balancing zone 14.

In some embodiments, in the preheating mode, the fresh air damper 25 of the fresh air flow path 15 is closed, and the exhaust moisture fan 91 and the exhaust moisture damper 94 of the exhaust moisture flow path 9 are closed. The hot air preheats the drum 1 by means of internal circulation, resulting in higher preheating efficiency.

The preheating mode has multiple flow path setup methods: The first method: close the exhaust moisture fan 91, exhaust moisture damper 94, fresh air damper 25, concurrent-flow hot air damper 24, concurrent-flow exhaust damper 95, and open the hot air fan 21, heater 22, return air damper 26, counter-flow hot air damper 23, counter-flow exhaust damper 96. The second method: close the exhaust moisture fan 91, exhaust moisture damper 94, fresh air damper 25, counter-flow hot air damper 23, counter-flow exhaust damper 96, and open the hot air fan 21, heater 22, return air damper 26, concurrent-flow hot air damper 24, concurrent-flow exhaust damper 95. The third method: close the exhaust moisture fan 91, exhaust moisture damper 94, fresh air damper 25, and open the hot air fan 21, heater 22, return air damper 26, concurrent-flow hot air damper 24, concurrent-flow exhaust damper 95, counter-flow hot air damper 23, counter-flow exhaust damper 96.

The purpose of the preheating mode is to raise the temperature of each zone of the drum 1 to the set value. The technical solution of the embodiment of the present disclosure uses the method of hot air circulating inside the drum 1, without exhaust moisture and without introducing fresh air, so the preheating efficiency is higher, and the preheating operation is more energy-saving.

After the above step S1, the drum wall temperatures of the four zones inside the drum 1 and the hot air temperature inside the drum 1 rise to their respective set temperature ranges for the preheating mode and are maintained until entering the material head mode. In the preheating mode, the respective temperature value ranges for the preheating and temperature rising zone 11, isothermal drying zone 12, moisture adjustment zone 13, and heat preservation and balancing zone 14 are shown in the first row of examples in Table 1: temperature value ranges for preheating and temperature rising zone 11 is 100±1 °C, temperature value ranges for isothermal drying zone 12 is 110±1 °C, temperature value ranges for moisture adjustment zone 13 is 100±1 °C, and temperature value ranges for heat preservation and balancing zone 14 is 95±1 °C.

Step S2, after the temperatures of all zones of the drum 1 reach the set values in the preheating mode, and after detecting incoming material is detected, adjust the material drying equipment to the material head mode. The following method is used to determine whether incoming material is detected: a conveying device is provided upstream of the material drying equipment, and the conveying device is provided with a detection device. When this detection device detects a material-present signal, it means that incoming material has arrived.

In step S2, in the material head mode, referring to Table 4, the exhaust moisture fan 91 is turned on and its frequency is gradually increased; the fresh air damper 25 is opened and its opening degree is gradually increased; the exhaust moisture damper 94 is opened and its opening degree is gradually increased, not necessarily to 100%. Because in the material head mode, the amount of material in the drum 1 is very small, and the requirement for the dehydration capacity of the material drying equipment is low, so the opening degrees of the fresh air damper 25, exhaust moisture damper 94, and the frequency of the exhaust moisture fan 91 do not need to be particularly high.

Step S3, when the duration of the material head mode reaches T_{sb} or the maximum moisture content of the dried material output in the material head mode is higher than the set minimum moisture content Aₘᵢₙ % of the dried material, adjust the material drying equipment to the production mode.

The control logic for transitioning from the preheating mode to the material head mode and then to the production mode is as follows: after the material drying equipment is preheated and meets the feeding conditions, it waits for the production line to feed material. When the material starts to enter the drum 1, the material drying equipment adjusts to the parameters of the material head mode, stably and continuously conveying material to the drum 1. When the material has been entering the drum 1 for the material head duration T_{sb} or the moisture gauge 6 detects that the maximum moisture content of the dried material is greater than the minimum moisture content Aₘᵢₙ %, slowly increase the operating frequency of the exhaust moisture fan 91 and the opening degrees of the exhaust moisture damper 94 and fresh air damper 25, and synchronously decrease the opening degree of the return air damper 26, then immediately enter the production mode.

Continue to refer to Table 4. In the normal production mode, the opening degree of the fresh air damper is 100%, the opening degree of the exhaust moisture damper is 100%, and the exhaust moisture air flow rate is controlled by adjusting the operating frequency of the exhaust moisture fan. The return air damper is closed, i.e., the opening degree is 0%. Alternatively, in the production mode, the opening degrees of the exhaust moisture damper in the exhaust moisture flow path and the fresh air damper in the fresh air flow path are both 100%, the air flow rate of the exhaust moisture flow path is achieved by adjusting the operating frequency of the exhaust moisture fan, the air flow rate of the fresh air flow path is achieved by adjusting the opening degree of the fresh air damper, and the opening degree of the return air damper of the material drying equipment is 0%. The material drying equipment can adopt counter-flow mode, concurrent-flow mode, or mixed-flow mode. If the concurrent-flow mode is used to dry the material, then the opening degree of the concurrent-flow hot air damper is 100%, the opening degree of the concurrent-flow exhaust damper is 100%, the opening degree of the counter-flow hot air damper is 0%, and the opening degree of the counter-flow exhaust damper is 0%. If the counter-flow mode is used to dry the material, then the opening degree of the concurrent-flow hot air damper is 0%, the opening degree of the concurrent-flow exhaust damper is 0%, the opening degree of the counter-flow hot air damper is 100%, and the opening degree of the counter-flow exhaust damper is 100%. If the mixed-flow mode is used to dry the material, then the opening degree of the concurrent-flow hot air damper is 100%, the opening degree of the concurrent-flow exhaust damper is 100%, the opening degree of the counter-flow hot air damper is 100%, and the opening degree of the counter-flow exhaust damper is 100%.

In the production mode, the exhaust gas containing steam evaporated from the material is discharged out of the equipment through the exhaust moisture flow path 9, while the hot air heated by the heater 22 is completely dry fresh air, improving the relative humidity of the process hot air, thereby increasing the dehydration rate of the material and improving the drying capacity of the equipment.

In the production mode, the temperature in the preheating and temperature rising zone 11 is t₁₋₃±Δt₁₋₃, the drum wall temperature in the isothermal drying zone 12 is t₂₋₃±Δt₂₋₃, the drum wall temperature in the moisture adjustment zone 13 is t₃₋₃±Δt₃₋₃, and the temperature in the heat preservation and balancing zone 14 is t₄₋₃±Δt₁₋₃; the ambient temperature is t₀; wherein, to S t₁≤t₂≥t₃≥t₄≥t₀.

In the production mode, the drying process of the material in the four zones of the drum 1 is as follows: the material first enters the preheating and temperature rising zone 11, where the drum wall temperature is t₁₋₃±Δt₁₋₃, causing the material and the moisture within the material to heat up, and preparing for rapid dehydration of the material; then, the material enters the isothermal drying zone 12, where the drum wall temperature is t₂₋₃ #Δt₂₋₃, keeping the material basically at a constant temperature for rapid dehydration and conducting relatively intense chemical reactions; next, the material enters the moisture adjustment zone 13, where the drum wall temperature is t₃₋₃±Δt₃₋₃, and the material continues to dehydrate in this zone, but the dehydration rate and chemical reaction rate of the material decrease significantly in this zone. The drum wall temperature in this zone is feedback-controlled by the moisture content of the dried material; then, the material enters the heat preservation and balancing zone 14, where the drum wall temperature is t₄₋₃±Δt₄₋₃. In the heat preservation and balancing zone 14, the temperature of the material no longer rises, reducing or even avoiding breakage caused by too large a temperature difference between the material and the environment, and reducing or even avoiding reduced processability due to continuous high-temperature drying of the material. The temperature and moisture content between materials can be balanced in the heat preservation and balancing zone 14, making the temperature and moisture content between materials in different parts more uniform. Finally, the material enters the cooling and setting zone 8′ inside the discharge hood 8. Inside the discharge hood 8, the material encounters the natural air head-on during free fall, intensifying heat exchange, allowing the material to undergo preliminary cooling before entering the natural environment, and achieving setting during the cooling process, improving filling capacity of the material, and reducing or even avoiding increased material breakage due to a too high cooling rate when the dried material enters the conveying device 7.

In the production mode, (t₄₋₃±Δt₄₋₃)≤(t₃₋₃±Δt₃₋₃), i.e., the temperature t₄ of the heat preservation and balancing zone is always not higher than the temperature t₃ of the moisture adjustment zone 13, so that the material in the heat preservation and balancing zone 14 either does not heat up or heats up only slightly. Afterwards, the material falls freely from the discharge hood 8 onto the conveying device 7, and during free fall, it collides head-on with natural air, further enhancing the cooling effect. Based on this, the material slowly cools down during the continuous dehydration process, reducing the cooling rate of the material, reducing material breakage, and further improving the uniformity of the moisture content of the dried material and the uniformity of cooling.

Among the various modes, the production mode lasts the longest, and the drying effect of the material mainly depends on the production mode. In the production mode, it is necessary to detect the temperature and moisture content of the dried material and the relative humidity of the exhaust moisture air in real time to control the drying effect.

In the production mode, when the relative humidity of the exhaust moisture air is greater than the set relative humidity RHₒᵤₜ+Δ RHₒᵤₜ of exhaust moisture air, then increase the operating frequency of the hot air fan 22, thereby increasing the hot air flow rate Qₕₒₜ₋₃; when the relative humidity of the exhaust moisture air is less than the set relative humidity RHₒᵤₜ−Δ RHₒᵤₜ of exhaust moisture air, then decrease the operating frequency of the hot air fan 22, thereby decreasing the hot air flow rate Qₕₒₜ₋₃. Whether increasing or decreasing the hot air flow rate, it is necessary to: ensure that the exhaust moisture air flow rate Qₒᵤₜ always equals the hot air flow rate Qₕₒₜ plus the natural air flow rate Q_{new}, i.e., Qₒᵤₜ=Qₕₒₜ+Q_{new}.

Because the relative humidity of the exhaust moisture air affects the dehydration rate of the material in the drum 1. When the relative humidity of the exhaust moisture air is high, the dehydration rate of the material is small. At this time, increase the hot air flow rate to reduce the relative humidity of the hot air in the drum 1, preventing the dehydration rate of the material from decreasing. When the relative humidity of the exhaust moisture air is low, the opposite is true, thereby maintaining a relatively stable dehydration rate of the material.

In the production mode, if the moisture content of the material output after drying by the drum 1 is greater than the set moisture content A %+ΔA % of the dried material, then increase the hot air flow rate Qₕₒₜ₋₃ and/or raise the drum wall temperature t₃₋₃ in the moisture adjustment zone 13; if the moisture content of the material output after drying by the drum 1 is less than the set moisture content A %−ΔA % of the dried material, then decrease the hot air flow rate Qₕₒₜ₋₃ and/or lower the drum wall temperature t₃₋₃ in the moisture adjustment zone 13. Ultimately, the moisture content of the material after adjustment is within the required range.

In the production mode, the moisture gauge 6 is used to measure the moisture content of the material conveyed by the conveying device 7 in real time. This material is the dried material. The specific steps of adjusting moisture content of the material are as follows:

First case: In the production mode, if the moisture content of the material output after drying by the drum 1 is greater than the set moisture content A %+ΔA % of the dried material, then perform adjustment according to the following steps: raise the drum wall temperature t₃₋₃ in the moisture adjustment zone 13; if after raising the drum wall temperature t₃₋₃ in the moisture adjustment zone 13 to t₃₋₃+Δt₃₋₃, the moisture content of the material output after drying by the drum 1 is still greater than the set moisture content A %+ΔA % of the dried material, then increase the hot air flow rate Qₕₒₜ₋₃.

Second case: In the production mode, if the moisture content of the material output after drying by the drum 1 is less than the set moisture content A %−ΔA % of the dried material, then perform adjustment according to the following steps: lower the drum wall temperature t₃₋₃ in the moisture adjustment zone 13; if after lowering the drum wall temperature t₃₋₃ in the moisture adjustment zone 13 to t₃₋₃−Δt₃₋₃, the moisture content of the material output after drying by the drum 1 is still less than the set moisture content A %−ΔA % of the dried material, then decrease the hot air flow rate Qₕₒₜ₋₃.

Both the first case and second case above adopt a two-stage adjustment: The first-stage adjustment is to adjust the drum wall temperature t₃₋₃ of the drum 1 in the moisture adjustment zone 13 in real time based on the moisture content of the dried material detected by the moisture gauge 6. When the moisture content of the dried material is greater than A %+ΔA %, increase the drum wall temperature t₃₋₃ by increasing the power of the heating component outside this zone; when the moisture content of the dried material is lower than A %−ΔA %, decrease the drum wall temperature t₃₋₃ by decreasing the power of the heating component outside this zone. When adjusting the drum wall temperature in the moisture adjustment zone 13, always maintain t₂₋₃≥t₃₋₃≥t₄₋₃.

Since most of the moisture has been evaporated from the material after dry and dehydration in the preheating and temperature rising zone 11 and the isothermal drying zone 12, the moisture content of the material is relatively low. At this time, the material enters the moisture adjustment zone 13. Fluctuations in the drum wall temperature t₃₋₃ have less impact on the sensory quality of the material, and the moisture adjustment zone 13 is closer to the detection location of the moisture content of the dried material, and the subsequent the temperature and moisture content of the material is balanced in the heat preservation and balancing zone 14. Using the first-stage adjustment helps to ensure the stability of the product sensory quality and improves the stability and adjustment sensitivity of the moisture content control of the dried material.

If after using the first-stage adjustment, the moisture content of the material still does not meet the requirements, then the second-stage adjustment is used: when the drum wall temperature t₃₋₃ in the moisture adjustment zone 13 is raised to t₃₋₃+Δt₃₋₃, and the moisture content of the dried material is still higher than A %+ΔA %, then increase the hot air flow rate Qₕₒₜ₋₃; when the drum wall temperature t₃₋₃ in the moisture adjustment zone 13 is lowered to t₃₋₃−Δt₃₋₃, and the moisture content of the dried material is still lower than A %−ΔA %, then decrease the hot air flow rate Qₕₒₜ₋₃. Whether increasing or decreasing the hot air flow rate, it is necessary to: ensure that the exhaust moisture air flow rate Qₒᵤₜ always equals the hot air flow rate Qₕₒₜ plus the natural air flow rate Q_{new}, i.e., Qₒᵤₜ=Qₕₒₜ+Q_{new}.

The temperature gauge 5 detects the temperature of the dried material after processing by the material drying equipment in real time. The method for adjusting the material temperature in the production mode is: in the production mode, when the temperature of the dried material is greater than Tₒᵤₜ+ΔTₒᵤₜ, increase the exhaust moisture air flow rate Qₒᵤₜ₋₃, thereby increasing the natural air flow rate, i.e., the fresh air flow rate Q_{new}; when the temperature of the dried material is less than Tₒᵤₜ−ΔTₒᵤₜ, decrease the exhaust moisture air flow rate Qₒᵤₜ₋₃, thereby decreasing the natural air flow rate, i.e., the fresh air flow rate Q_{new}. Whether increasing or decreasing the exhaust moisture air flow rate, it is necessary to: ensure that the exhaust moisture air flow rate Qₒᵤₜ always equals the hot air flow rate Qₕₒₜ plus the natural air flow rate Q_{new}, i.e., Qₒᵤₜ=Qₕₒₜ+Q_{new}.

In the production mode, whether adjusting the material temperature or the material moisture content, as long as it involves adjusting the exhaust moisture air flow rate or the hot air flow rate, it is necessary to: ensure that the exhaust moisture air flow rate Qₒᵤₜ always equals the hot air flow rate Qₕₒₜ plus the natural air flow rate Q_{new}, i.e., Qₒᵤₜ=Qₕₒₜ+Q_{new}.

The temperature of the dried material is affected by the cooling effect in the cooling and setting zone 8′. When the material temperature is high, it indicates that the cooling effect in the cooling and setting zone 8′ does not meet the process requirements, and it is necessary to increase the natural air flow rate Q_{new} used for cooling, so that more cold air in the cooling and setting zone 8′ intensifies heat exchange with the material. This is achieved by increasing the exhaust moisture air flow rate Qₒᵤₜ; when the material temperature is low, it indicates that the cooling effect in the cooling and setting zone 8′ exceeds the process requirements, and it is necessary to decrease the natural air flow rate Q_{new} used for cooling, so that less cold air in the cooling and setting zone 8′ exchanges heat with the material. This is achieved by decreasing the exhaust moisture air flow rate Qₒᵤₜ.

Step S4, after the production mode ends, adjust the material drying equipment to the material tail mode.

The conveying device 7 is located upstream of the material drying equipment. When the material detection device provided on the conveying device 7 detects a no-material signal and delays for a set time, adjust the material drying equipment from the production mode to the material tail mode: slowly decrease the opening degrees of the exhaust moisture damper 94 and the fresh air damper 25, and synchronously increase the opening degree of the return air damper 26. As the material flow rate gradually decreases, to ensure that the moisture content of the material in the tail stage is not too low, the relative humidity of the hot air is quickly increased to reduce the dehydration rate of the material, improving the stability of the material moisture content, thereby reducing material loss.

Referring to Table 1, in the material drying method described above, in the preheating mode, the temperature in the preheating and temperature rising zone 11 of the drum 1 is lower than the temperature in the preheating and temperature rising zone 11 of the drum 1 in the material head mode, the production mode, and the material tail mode. The preheating mode only needs to raise the temperature of the drum 1 to a level close to that required for the material head mode. The material inside the drum 1 first passes through the preheating and temperature rising zone 11, then through the isothermal drying zone 12, then flows through the moisture adjustment zone 13, and finally passes through the heat preservation and balancing zone 14.

Continue to refer to Table 1. Since the amount of material in the drum 1 is relatively small in both the material head mode and the material tail mode, the set temperatures in any one of the four zones in the material head mode and the material tail mode are approximately the same: that is, the set temperature in the preheating and temperature rising zone 11 in the material head mode is the same as that in the material tail mode, the set temperature in the isothermal drying zone 12 in the material head mode is the same as that in the material tail mode, the set temperature in the moisture adjustment zone 13 in the material head mode is the same as that in the material tail mode, and the set temperature in the heat preservation and balancing zone 14 in the material head mode is the same as that in the material tail mode.

Based on the above set temperatures, in the material head mode, the amount of material in the drum 1 increases from less to more, and the drum wall temperature gradually increases from low to high, so as to the production stage, thereby gradually increasing the dehydration capacity of the equipment; whereas in the material tail mode, the amount of material in the drum 1 decreases from more to less, and the drum wall temperature gradually decreases from high to low from the set temperature of the production mode, thereby reducing the dehydration capacity of the equipment.

Compared with the production mode, the material tail mode has lower exhaust moisture demand, lower requirement for fresh air flow rate, and higher requirement for return air flow rate. In the material tail mode, the opening degree of the exhaust moisture damper 94 of the exhaust moisture flow path 9 is less than the opening degree of the exhaust moisture damper in the exhaust moisture flow path in the production mode, or the operating frequency of the exhaust moisture fan 91 is reduced. Alternatively, in the material tail mode, the frequency of the exhaust moisture fan 91 of the exhaust moisture flow path is less than the operating frequency of the exhaust moisture fan in the exhaust moisture flow path in the production mode. In the material tail mode, the opening degree of the fresh air damper 25 of the fresh air flow path 15 is less than the opening degree of the fresh air damper in the fresh air flow path in the production mode, or the operating frequency of the hot air fan 21 is reduced. In the material tail mode, the opening degree of the return air damper 26 of the material drying equipment is greater than the opening degree of the return air damper in the production mode.

After the above step S4, the material drying method further includes the following step:

Step S5, adjust the material drying equipment from the material tail mode to the shutdown mode.

When the material detection devices on both the upstream and downstream conveying devices of the material drying equipment detect no-material signals, it indicates that there is no more material. At this time, adjust the material drying equipment from the material tail mode to the shutdown mode. When the exhaust moisture air temperature Tₒᵤₜ is less than or equal to the set value and the drum wall temperatures of the four zones are all less than or equal to the set temperatures, the equipment shuts down and stops running.

In the shutdown mode, when the exhaust moisture air temperature Tₒᵤₜ is less than or equal to the set value, and the drum wall temperatures in the preheating and temperature rising zone 11, the isothermal drying zone 12, the moisture adjustment zone 13, and the heat preservation and balancing zone 14 are all less than or equal to their respective set temperatures, the material drying equipment shuts down and stops running.

Referring to Table 4, in the shutdown mode, the return air damper 26 of the material drying equipment, the heater 22 of the hot air flow path 2, and the heating components outside the drum 1 are all closed. All other dampers are opened.

In some embodiments, in the above steps S2 to S4, each step includes the following operations: detecting the moisture content of the material output after drying by the drum 1; if the moisture content of the material detected by the moisture gauge 6 is greater than the set maximum moisture content Aₘₐₓ % of the dried material or less than the set minimum moisture content Aₘᵢₙ % of the dried material, then discard this material. In the material head mode, production mode, and material tail mode, as long as the obtained material moisture content does not meet the requirements, the material must be discarded to improve the quality of the finished product.

The material dried by the material drying equipment is preliminarily cooled in the cooling and setting zone 8′ inside the discharge hood and then delivered from the discharge outlet 81 to the conveying device 7. During the conveying process by the conveying device 7, the material continues to cool and set and volatilizes a small amount of surface moisture, and the material is conveyed to the next process by the conveying device 7. Before the material is conveyed to the next process, unqualified material is discarded by the discarding device 71 on the conveying device 7.

The moisture content of the material is detected in real time by the moisture gauge 6 installed above the conveying device 7. When the material moisture content is higher than Aₘₐₓ % or lower than Aₘᵢₙ %, the discarding device 71 on the conveying device 7 is activated, and the material with unqualified moisture content is discarded through the discarding device. Material with moisture content greater than Aₘₐₓ % and material with moisture content less than Aₘᵢₙ % are unqualified materials and need to be discarded to avoid product quality issues. The maximum moisture content Aₘₐₓ % and the minimum moisture content Aₘᵢₙ % of the material are issued as standards by the process department.

The following describes some specific embodiments, taking the material drying equipment for drying A cut tobacco as an example.

Material drying equipment parameters: the length of the Drum 1 is 6000 mm (wherein, the length of the preheating and temperature rising zone 11 is 1150 mm, the length of the isothermal drying zone 12 is 1300 mm, the length of the moisture adjustment zone 13 is 1150 mm, the length of the heat preservation and balancing zone 14 is 1150 mm), the diameter of the drum 1 is 800 mm, inclination angle of drum 1 from feed end to discharge end (from high to low) is 3°, rated air flow rate of hot air fan 21 is 2100 m³/h. The length of the isothermal drying zone 12 is slightly longer than the respective lengths of the preheating and temperature rising zone 11, the moisture adjustment zone 13, and the heat preservation and balancing zone 14. The lengths of the preheating and temperature rising zone 11, the moisture adjustment zone 13, and the heat preservation and balancing zone 14 are basically the same. In FIG. 1, Direction A is the flow direction of the exhaust gas (mixed gas of process hot air and natural air); Direction B is the flow direction of the process hot air; Direction C is the flow direction of the dried material.

Process parameters: material flow rate is 500 kg/h, moisture content of material before drying is 20.0%±1.5%, moisture content of dried material is 12.8%±0.5%, temperature of material before drying is 28±2 °C, material drying time is about 270 s, filling value of dried material is greater than 3.8 cm³/g. Under high-temperature working conditions, such as in summer, temperature of material before drying is 32±2 °C, material drying time is about 220 s, other parameters are the same as above.

Preheating mode parameters: The drum wall temperatures of the four zones are set to 100±1 °C, 110±1 °C, 100±1 °C, 95±1 °C respectively, hot air flow rate is 900±100 m³/h, hot air temperature is 100±1 °C, exhaust moisture air flow rate is 0 m³/h.

Material head mode parameters: material head duration T_{sb}=360 s, the drum wall temperatures of the four zones are set to 105±2 °C, 118±2 °C, 105±5 °C, 100±2 °C respectively, hot air flow rate is 400=100 m³/h, hot air temperature is 100±2 °C, exhaust moisture air flow rate Qₒᵤₜ−2=550=100 m³/h.

Production mode parameters: The drum wall temperatures of the four zones are set to 110±0.5 °C, 128=0.5 °C, 110±10 °C, 105±0.5 °C respectively, hot air flow rate is 1000±100 m³/h, hot air temperature is 102±0.5 °C, exhaust moisture air flow rate is 1200-1800 m³/h, exhaust moisture air relative humidity is 50±5%, moisture content of dried material is 12.8%±0.5%, temperature of dried material is 45±3 °C.

Material tail mode parameters: The drum wall temperatures of the four zones are set to 105±2 °C, 120±2 °C, 105±5 °C, 100±2 °C respectively, hot air flow rate is 500±100 m³/h, hot air temperature is 100±2 °C, exhaust moisture air flow rate is 650±100 m³/h.

Shutdown mode parameters: close the return air damper 26, the heater 22, and the heating components outside the drum wall in the corresponding zones of the preheating and temperature rising zone 11, isothermal drying zone 12, moisture adjustment zone 13, and heat preservation and balancing zone 14 of the drum 1 (not shown in the figure), set all other valves to 100% opening degree, increase the operating frequency of the exhaust moisture fan 91 and/or the hot air fan 21, set the exhaust moisture air temperature to 60 °C, and set the drum wall temperatures of the four zones to t₁₋₅=t₂₋₅=t₃₋₅=t₄₋₅=60 °C.

Set the maximum moisture content of the dried material to 14.5%, and the minimum moisture content of the dried material to 7.0%.

Production process control is as follows:

(1) Adjust to the parameters of the preheating mode, close the exhaust moisture fan 91, exhaust moisture damper 94, fresh air damper 25, counter-flow hot air damper 23, counter-flow exhaust damper 96, and open the hot air fan 21, heater 22, return air damper 26, concurrent-flow hot air damper 24, concurrent-flow exhaust damper 95.

(2) Start the production line and preheat the material drying equipment so that the drum wall temperatures in the four zones of the drum 1 and the hot air temperature are within the parameter range of the preheating mode.

(3) After the drum dryer is preheated and meets condition (2), it can start production by feeding material. When the material starts to enter the drum 1, adjust to the parameters of the material head mode and stably and continuously feed material to the material drying equipment. When the material has been entering the drum for 360 s or the moisture gauge 6 detects that the moisture content of the dried material is greater than the minimum moisture content of 7.0%, start the exhaust moisture fan 91, slowly increase the opening degrees of the exhaust moisture damper 94 and the fresh air damper 25, and synchronously decrease the opening degree of the return air damper 26, then immediately enter the production mode.

(4) Adjust to the parameters of the production mode, with the opening degrees of the exhaust moisture damper 94 and the fresh air damper 25 at 100%, and the opening degree of the return air damper 26 at 0%.

(5) The material first enters the preheating and temperature rising zone 11, where the material and the moisture within the material are heated up, preparing for rapid dehydration of the material; then, the material enters the isothermal drying zone 12, where the material is kept basically at a constant temperature for rapid dehydration and conducts relatively intense chemical reactions; next, the material enters the moisture adjustment zone 13, where the material continues to dehydrate, but the dehydration rate and chemical reaction rate of the material decrease significantly in this zone; then, the material enters the heat preservation and balancing zone 14, where the temperature of the material no longer rises, to avoid breakage due to too large a temperature difference between the material and the environment and reduced processability due to continuous high-temperature drying of the material. The main function of this zone is to balance the temperature and moisture content between materials, making the temperature and moisture content between materials in different parts more uniform; finally, the material enters the cooling and setting zone 8′ inside the discharge hood 8, where the material encounters the natural air head-on during free fall, intensifying heat exchange, allowing the material to undergo preliminary cooling before entering the natural environment, and achieving setting during the cooling process, improving filling capacity of the material, and reducing or even avoiding increased material breakage due to a too high cooling rate when the dried material enters the conveying device 7.

(6) In the production mode, the exhaust gas humidity gauge 92 detects the relative humidity of the exhaust moisture air in real time. When the relative humidity of the exhaust moisture air is greater than 50%+5%, increase the operating frequency of the hot air fan 22, thereby increasing the hot air flow rate; when the relative humidity of the exhaust moisture air is less than 50%−5%, decrease the operating frequency of the hot air fan 22, thereby decreasing the hot air flow rate; keep the relative humidity of the exhaust moisture air always within the range of 45% to 55%.

When adjusting the hot air flow rate, synchronously adjust the exhaust moisture air flow rate to ensure that Qₒᵤₜ=Qₕₒₜ+Q_{new} is satisfied.

(7) In the production mode, during the conveying process of the material on the conveying device 7, the moisture gauge 6 detects the moisture content of the material after processing by the material drying equipment in real time. When the moisture content of the dried material is greater than 12.8%+0.5%, increase the hot air flow rate and/or raise the drum wall temperature in the moisture adjustment zone 13. When the moisture content of the dried material is less than 12.8%-0.5%, decrease the hot air flow rate and/or lower the drum wall temperature in the moisture adjustment zone 13;

When adjusting the hot air flow rate, the exhaust moisture air flow rate should be adjusted synchronously to ensure that Qₒᵤₜ=Qₕₒₜ+Q_{new} is satisfied.

(8) First-stage adjustment of the moisture content of the dried material: The moisture gauge 6 detects the moisture content of the material after processing by the material drying equipment in real time. Based on the moisture content of the dried material detected by the moisture gauge 6, adjust the drum wall temperature in the moisture adjustment zone 13 of the drum 1 in real time. When the moisture content of the dried material is greater than 12.8%+0.5% (13.3%), increase the drum wall temperature by increasing the power of the heating component outside the drum wall in this zone, but the drum wall temperature in the moisture adjustment zone 13 must not exceed 120 °C. When the moisture content of the dried material is lower than 12.8%−0.5% (12.3%), decrease the drum wall temperature by decreasing the power of the heating component outside the drum wall in this zone, but the drum wall temperature in the moisture adjustment zone 13 must not be lower than 100 °C.

(9) Second-stage adjustment of the moisture content of the dried material: Through step (8), adjust the drum wall temperature in the moisture adjustment zone 13. When the drum wall temperature is raised to 120 °C, and the moisture content of the dried material is still higher than 12.8%+0.5% (13.3%), then increase the hot air flow rate; when the drum wall temperature is lowered to 100 °C, and the moisture content of the dried material is still lower than 12.8%−0.5% (12.3%), then decrease the hot air flow rate, keeping the moisture content of the dried material within the range of 12.3% to 13.3%.

When adjusting the hot air flow rate, the exhaust moisture air flow rate should be adjusted synchronously to ensure that Qₒᵤₜ=Qₕₒₜ+Q_{new} is satisfied.

(10) The temperature gauge 5 detects the temperature of the material after processing by the material drying equipment in real time. When the temperature of the dried material is greater than 45 °C+3 °C, increase the exhaust moisture air flow rate, thereby increasing the natural air flow rate; when the temperature of the dried material is less than 45 °C−3 °C, decrease the exhaust moisture air flow rate, thereby decreasing the natural air flow rate;

When adjusting the exhaust moisture air flow rate, the hot air flow rate should be maintained, and the natural air flow rate is adjusted synchronously to ensure that Qₒᵤₜ=Qₕₒₜ+Q_{new} is satisfied.

(11) The hot air temperature gauge 27 detects the hot air temperature in real time: when the hot air temperature is higher than the set value, decrease the power of the heater 22; when the hot air temperature is lower than the set value, increase the power of the heater 22. The first temperature sensor 111 detects the drum wall temperature in the preheating and temperature rising zone 11 in real time: when the drum wall temperature is higher than the set value, decrease the power of the heating component outside the drum wall in the preheating and temperature rising zone 11; when the drum wall temperature in the preheating and temperature rising zone 11 is lower than the set value, increase the power of the heating component outside the drum wall in the preheating and temperature rising zone 11. The second temperature sensor 121 detects the drum wall temperature in the isothermal drying zone 12 in real time: when the drum wall temperature in the isothermal drying zone 12 is higher than the set value, decrease the power of the heating component outside the drum wall in the isothermal drying zone 12; when the drum wall temperature in the isothermal drying zone 12 is lower than the set value, increase the power of the heating component outside the drum wall in the isothermal drying zone 12. The third temperature sensor 131 detects the drum wall temperature in the moisture adjustment zone 13 in real time: when the drum wall temperature in the moisture adjustment zone 13 is higher than the set value, decrease the power of the heating component outside the drum wall in the moisture adjustment zone 13; when the drum wall temperature in the moisture adjustment zone 13 is lower than the set value, increase the power of the heating component outside the drum wall in the moisture adjustment zone 13. The fourth temperature sensor 141 detects the drum wall temperature in the heat preservation and balancing zone 14 in real time: when the drum wall temperature in the heat preservation and balancing zone 14 is higher than the set value, decrease the power of the heating component outside the drum wall in the heat preservation and balancing zone 14; when the drum wall temperature in the heat preservation and balancing zone 14 is lower than the set value, increase the power of the heating component outside the drum wall in the heat preservation and balancing zone 14.

(12) When the material detection device on the upstream conveying device of the material drying equipment detects a no-material signal, adjust to the parameters of the material tail mode, slowly decrease the opening degree of the exhaust moisture damper 94 or the operating frequency of the exhaust moisture fan 91 and the opening degree of the fresh air damper 25, and synchronously increase the opening degree of the return air damper 26.

(13) When the material detection devices on both the upstream and downstream conveying devices of the material drying equipment detect no-material signals, adjust to the parameters of the shutdown mode. When the exhaust moisture air temperature is less than or equal to the set value of 60 °C and the drum wall temperatures in the four zones are all less than or equal to the set temperature of 60 °C, the equipment shuts down and stops running.

(14) The material dried by the material drying equipment is preliminarily cooled in the cooling and setting zone 8′ inside the discharge hood and then delivered from the discharge outlet 81 to the conveying device 7. During the conveying process on the conveying device 7, the material continues to cool and set and volatilizes a small amount of surface moisture, and the material is conveyed to the next process by the conveying device 7.

(15) In the above steps, the material drying method also includes discarding of unqualified dried material. The moisture gauge 6 installed above the conveying device 7 detects the moisture content of the material in real time. When the material moisture content is higher than 14.5% or lower than 7.0%, activate the discarding device 71 on the conveying device 7, and discard the material with unqualified moisture content by the discarding device to avoid product quality issues.

The material drying method based on precise moisture content control provided by the above technical solution, through zonal and segmented adjustment of the control parameters of the material drying equipment and two-stage feedback control of the target moisture content of the dried material, abandons the traditional extensive drying mode, achieving more precise, efficient, environmentally friendly, and higher-quality material drying, with better product sensory quality and physical quality, completely solving the impact of changes in ambient temperature and humidity and the temperature and humidity of the incoming material on the drying results. Compared with the existing technology, the technical solution of the embodiment of the present disclosure has the following advantages:

First, the temperature and moisture content of the material processed by the material drying equipment are more uniform, and the stability of temperature and moisture content is greatly improved.

Second, through material preheating and material pre-cooling, excessive loss of soluble substances in the material is avoided, achieving the effect of enhancing and increasing aroma, and improving the material quality and sensory quality of the product.

Third, except for the main drying zone (isothermal drying zone 12), the material drying temperature is lower, allowing the material to maintain higher mechanical properties and processability, thereby reducing material breakage, improving material utilization rate, and making the material more elastic.

Fourth, through pre-cooling in the cooling and setting zone, the cooling and setting effect of the material is better, its filling capacity is improved, the temperature difference between the material and the natural environment is reduced, and material breakage is further reduced.

Fifth, when the moisture content of the dried material is high or low, through the two-stage adjustment method, first adjust the drum wall temperature in the moisture adjustment zone 13, and then adjust the hot air flow rate. This method makes adjustment of the material moisture content more sensitive and make the control more precise.

Sixth, based on the control modes for the material head and material tail, the material head stage and material tail stage have higher relative humidity of the hot air, thereby reducing the dehydration rate of the material and reducing the amount of unqualified material during production stages of the material head and material tail.

The embodiment of the present disclosure provides a material drying system, including a memory and a processor coupled to the memory. The processor is configured to execute the material drying method according to any one of the preceding embodiments based on instructions stored in the memory.

The memory may, for example, include system memory, fixed non-transitory storage media, etc. The system memory stores, for example, an operating system, application programs, a boot loader, and other programs.

Some embodiments of the present disclosure also provide a computer-readable storage medium having a computer program stored thereon. When the program is executed by a processor, it implements the material drying method of the material drying equipment according to any one of the preceding embodiments.

The processors described herein may include a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Any connection is also properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Those skilled in the art will appreciate that the method embodiments of the present disclosure may be provided as a method, system, or computer program product. Accordingly, the present disclosure may take the form of an entirely hardware embodiment, an entirely software embodiment, or an embodiment combining software and hardware aspects. Furthermore, the present disclosure may take the form of a computer program product implemented on one or more computer-usable non-transitory storage media (including but not limited to disk storage, CD-ROM, optical storage, etc.) having computer-usable program code embodied therein.

The present disclosure is described with reference to flowchart illustrations and/or block diagrams of methods, apparatus (systems), and computer program products according to embodiments of the present disclosure. It will be understood that each flow and/or block of the flowchart illustrations and/or block diagrams, and combinations of flows and/or blocks in the flowchart illustrations and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flowchart flow or flows and/or block diagram block or blocks.

These computer program instructions may also be stored in a computer-readable memory that can direct a computer or other programmable data processing apparatus to function in a particular manner, such that the instructions stored in the computer-readable memory produce a manufactured article of including instruction means which implement the function specified in the flowchart flow or flows and/or block diagram block or blocks.

These computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart flow or flows and/or block diagram block or blocks.

In the description of the present disclosure, it is to be understood that the terms “center”, “longitudinal”, “transverse”, “front”, “rear”, “left”, “right”, “vertical”, “horizontal”, “top”, “bottom”, “inner”, “outer”, etc., indicate orientations or positional relationships based on those shown in the drawings, are merely for convenience of description of the present disclosure and simplified description, and do not indicate or imply that the referred device or element must have a specific orientation, be constructed and operated in a specific orientation, and therefore cannot be construed as limiting the protection scope of the present disclosure.

Finally, it should be noted that: the above embodiments are only used to illustrate the technical solutions of the present disclosure and not to limit them; although the present disclosure has been described in detail with reference to the preferred embodiments, those of ordinary skill in the art should understand that: modifications to the specific embodiments of the present disclosure or equivalent replacements of some technical features can still be made without departing from the spirit of the technical solutions of the present disclosure, they shall all be covered in the scope of the technical solutions claimed in the present disclosure.

1. A material drying method, comprising:
in a preheating mode, closing a fresh air flow path and an exhaust moisture flow path of a material drying equipment, and conducting a hot air flow path of the material drying equipment to preheat a drum of the material drying equipment; wherein, the drum is divided into a preheating and temperature rising zone, an isothermal drying zone, a moisture adjustment zone, and a heat preservation and balancing zone; the drum wall temperature in the moisture adjustment zone is feedback-controlled by the moisture content of the dried material;
when the temperatures of all zones of the drum after preheating reach set values, and incoming material is detected, adjusting the material drying equipment to a material head mode;
when the duration of the material head mode reaches T_{sb} or the maximum moisture content of the dried material output in the material head mode is higher than the set minimum moisture content Aₘᵢₙ % of the dried material, adjusting the material drying equipment to a production mode;
after the production mode ends, adjusting the material drying equipment to a material tail mode.

2. The material drying method according to claim 1, wherein in the preheating mode, the temperature in the preheating and temperature rising zone of the drum is lower than the temperature in the preheating and temperature rising zone of the drum in the material head mode, the production mode, and the material tail mode.

3. The material drying method according to claim 1, wherein in the preheating mode, the temperature in the isothermal drying zone of the drum is lower than the temperature in the isothermal drying zone of the drum in the material head mode, the production mode, and the material tail mode.

4. The material drying method according to claim 1, wherein in the preheating mode, the temperature in the moisture adjustment zone of the drum is lower than the temperature in the moisture adjustment zone of the drum in the material head mode, the production mode, and the material tail mode.

5. The material drying method according to claim 1, wherein in the preheating mode, the temperature in the heat preservation and balancing zone of the drum is lower than the temperature in the heat preservation and balancing zone of the drum in the material head mode, the production mode, and the material tail mode.

6. The material drying method according to claim 1, wherein in the production mode, the temperature in the preheating and temperature rising zone is t₁₋₃±Δt₁₋₃, the drum wall temperature in the isothermal drying zone is t₂₋₃±Δt₂₋₃, the drum wall temperature in the moisture adjustment zone is t₃₋₃±Δt₃₋₃, the temperature in the heat preservation and balancing zone is t₄₋₃±Δt₄₋₃; the ambient temperature is t₀; wherein, t₀≤t₁≤t₂≥t₃≥t₄≥t₀.

7. The material drying method according to claim 1, wherein in the preheating mode, the fresh air damper in the fresh air flow path is closed, the exhaust moisture fan in the exhaust moisture flow path is closed, and the exhaust moisture damper in the exhaust moisture flow path is closed.

8. The material drying method according to claim 1, wherein in the production mode, the opening degrees of the exhaust moisture damper in the exhaust moisture flow path and the fresh air damper in the fresh air flow path are both 100%, the air flow rate of the exhaust moisture flow path is achieved by adjusting the operating frequency of the exhaust moisture fan, the air flow rate of the fresh air flow path is achieved by adjusting the opening degree of the fresh air damper, and the opening degree of the return air damper of the material drying equipment is 0%; or, the opening degrees of the exhaust moisture damper in the exhaust moisture flow path and the fresh air damper in the fresh air flow path are both 100%, and the opening degree of the return air damper of the material drying equipment is 0%.

9. The material drying method according to claim 1, wherein in the material tail mode, the opening degree of the exhaust moisture damper in the exhaust moisture flow path is less than the opening degree of the exhaust moisture damper in the exhaust moisture flow path in the production mode; and/or, in the material tail mode, the operating frequency of the exhaust moisture fan in the exhaust moisture flow path is less than the operating frequency of the exhaust moisture fan in the exhaust moisture flow path in the production mode; and/or, in the material tail mode, the opening degree of the fresh air damper in the fresh air flow path is less than the opening degree of the fresh air damper in the fresh air flow path in the production mode; and/or, in the material tail mode, the opening degree of the return air damper of the material drying equipment is greater than the opening degree of the return air damper in the production mode.

10. The material drying method according to claim 1, wherein when a material detection device arranged on a conveying device detects a no-material signal and delays for a set time, the material drying equipment is adjusted from the production mode to the material tail mode; wherein, the conveying device is located upstream of the material drying equipment.

11. The material drying method according to claim 1, further comprising: after the material tail mode,
adjusting the material drying equipment from the material tail mode to a shutdown mode;
wherein when the material detection devices on both the upstream and downstream conveying devices of the material drying equipment detect no-material signals, the material drying equipment is adjusted from the material tail mode to the shutdown mode;
wherein when the exhaust moisture air temperature Tₒᵤₜ is less than or equal to a set value, and the drum wall temperatures in the preheating and temperature rising zone, the isothermal drying cone, the adjustment zone, and the heat preservation and balancing zone are all less than or equal to their respective set temperatures, the material diving equipment shuts down and stops running,
wherein in the shutdown mode, the return air damper of the material drying equipment the heater of the hot air flow path, and the heating component outside the drum are all closed.

12-14. (canceled)

15. The material drying method according to claim 1, wherein in the production mode, when the relative humidity of the exhaust moisture air is greater than the set relative humidity RHₒᵤₜ+Δ RHₒᵤₜ of exhaust moisture air, then increasing the hot air flow rate Qₕₒₜ₋₃; when the relative humidity of the exhaust moisture air is less than the set relative humidity RHₒᵤₜ−Δ RHₒᵤₜ of exhaust moisture air, then decreasing the hot air flow rate Qₕₒₜ₋₃.

16. The material drying method according to claim 1, wherein in the production mode, if the moisture content of the material output after drying by the drum (is greater than the set moisture content A %+ΔA % of the dried material, then increasing the hot air flow rate Qₕₒₜ₋₃ and/or raising the drum wall temperature t₃₋₃ in the moisture adjustment zone; if the moisture content of the material output after drying by the drum is less than the set moisture content A %−ΔA % of the dried material, then decreasing the hot air flow rate Qhot−3 and/or lower the drum wall temperature t₃₋₃ in the moisture adjustment zone.

17. The material drying method according to claim 5, wherein in the production mode, if the moisture content of the material output after drying by the drum is greater than the set moisture content A %+ΔA % of the dried material, then performing adjustment according to the following steps:
raising the drum wall temperature t₃₋₃ in the moisture adjustment zone;
if after raising the drum wall temperature t₃₋₃ in the moisture adjustment zone to t₃₋₃+Δt₃₋₃, the moisture content of the material output after drying by the drum is still greater than the set moisture content A %+ΔA % of the dried material, then increasing the hot air flow rate Qhot−3.

18. The material drying method according to claim 5, wherein in the production mode, if the moisture content of the material output after drying by the drum is less than the set moisture content A %−ΔA % of the dried material, then performing adjustment according to the following steps:
lowering the drum wall temperature t₃₋₃ in the moisture adjustment zone;
if after lowering the drum wall temperature t₃₋₃ in the moisture adjustment zone to t₃₋₃−Δt₃₋₃, the moisture content of the material output after drying by the drum is still less than the set moisture content A %−ΔA % of the dried material, then decreasing the hot air flow rate Qₕₒₜ₋₃.

19. The material drying method according to claim 1, wherein in the production mode, when the temperature of the dried material is greater than Tₒᵤₜ+ΔTₒᵤₜ, increasing the exhaust moisture air flow rate Qₒᵤₜ₋₃, thereby increasing the natural air flow rate Q_{new}; when the temperature of the dried material is less than Tₒᵤₜ−ΔTₒᵤₜ, decreasing the exhaust moisture air flow rate Qₒᵤₜ₋₃, thereby decreasing the natural air flow rate Q_{new}.

20. The material drying method according to claim 5, wherein in the production mode, always maintaining the exhaust moisture air flow rate Qₒᵤₜ equal to the hot air flow rate Qₕₒₜ plus the natural air flow rate Q_{new}, i.e., Qₒᵤₜ=Qₕₒₜ+Q_{new}.

21. The material drying method according to claim 1, wherein each of the material head mode, the production mode, and the material tail mode comprises the following operation:
detecting the moisture content of the material output after drying by the drum;
if the detected moisture content of the material is greater than the set maximum moisture content Aₘₐₓ % of the dried material or less than the set minimum moisture content Aₘᵢₙ % of the dried material, then discarding the material.

22. A material drying system, comprising:
a memory; and
a processor coupled to the memory, the processor being configured to execute the material drying method according to claim 1 based on instructions stored in the memory.

23. A computer-readable storage medium, having a computer program stored thereon, which when executed by a processor, implements the material drying method according to claim 1.
